(19) United States
(12) Patent Application Publication
(10) Pub. No.: US 2021/0368876 A1
(43) Pub. Date: Dec. 2, 2021

(54) FACE MASK AND METHOD FOR CONFORMING A FACE MASK TO A FACE

(71) Applicant: O2 Industries Inc., Kitchener (CA)

(72) Inventors: Richard Devin Szasz, Kitchener (CA); Peter Lionel Whitby, Kitchener (CA); Steven Henry Fyke, Waterloo (CA); Jason Griffin, Kitchener (CA)

(21) Appl. No.: 16/977,373

(22) PCT Filed: Mar. 1, 2019
(86) PCT No.: PCT/CA2019/050244

§ 371 Date: Sep. 1, 2020

Related U.S. Application Data
(60) Provisional application No. 62/637,467, filed on Mar. 2, 2018.

(51) Int. Cl. A41D 13/11; A62B 23/02

(52) U.S. Cl. CPC A41D 13/1146; A62B 23/025

(57) ABSTRACT

A face mask for filtering air includes a support defining an open area that provides for passage of air between the mouth and environment; a seal coupled to the support and extending rearwardly from the support, the seal sized and shaped to surround a nose and a mouth of a user and support the face mask on the user's face when the face mask is worn by the user; a moldable member extending rearwardly from a rear edge of the support, the moldable member increasing in malleability upon the application of heat and decreasing in malleability upon cooling; a front shell for removably attaching to the support, the front shell having inlet holes for facilitating passage of incoming air through the open area of the support; and a filter for filtering particulate elements from air, the filter configured to be housed between the front shell and the support.

### TECHNICAL FIELD

The embodiments disclosed herein relate to respirator masks and air monitoring systems, and, in particular to face masks for filtering air.

### INTRODUCTION

Respiratory masks are used in a wide variety of applications to protect a human's respiratory system from particles suspended in the air or from unpleasant or noxious gases. They are also frequently worn by, for example, medical care providers to prevent the spread of harmful micro-organisms either to or from the user.

Persons who work in polluted environments commonly wear filtering face masks to protect themselves from inhaling airborne contaminants. Filtering face masks typically have a fibrous or sorbent filter that is capable of removing particulate and/or gaseous contaminants from the air.

Respiratory masks have a variety of uses, including protecting a user from harmful bacteria or particles contained within unfiltered air. To be effective, respiratory masks need to fit closely to the user's face to inhibit inhalation of air that avoids passing through the fibrous or sorbent filter, such as air that passes through a space between the user's face and an edge of the respiratory mask when the respiratory mask does not properly conform to the user's face.

International PCT Application no. PCT/CA2017/051039, filed Sep. 5, 2017, entitled “Face Mask for Filtering Air and Air Monitoring System”, which is incorporated by reference in its entirety, describes a respiratory face mask.

Facial bone structures of people, including people from different ethnicities, vary in shape and size, making it difficult to design a respiratory mask that fits closely to faces of many different people.

Accordingly, there is a need for a face mask capable of conforming to the faces of people having various shaped and sized facial bone structures.

### SUMMARY

This summary is intended to introduce the reader to the more detailed description that follows and not to limit or define any claimed or as yet claimed invention. One or more inventions may reside in any combination or sub-combination of the elements or process steps disclosed in any part of this document including its claims and figures.

According to some embodiments, a face mask for filtering air is described herein. A face mask for filtering air is described herein. The face mask includes a support defining an open area that provides for passage of air between the mouth and environment; a seal coupled to the support and extending rearwardly from the support, the seal sized and shaped to surround a nose and a mouth of a user and support the face mask on the user's face when the face mask is worn by the user; a moldable member extending rearwardly from a rear edge of the support, the moldable member increasing in malleability upon the application of heat and decreasing in malleability upon cooling; a front shell for removably attaching to the support, the front shell having inlet holes for facilitating passage of incoming air through the open area of the support; and a filter for filtering particulate elements from air, the filter configured to be housed between the front shell and the support.

According to some embodiments, a method of conforming a face mask to a face of a user is described herein. The method includes: heating the face mask to increase a malleability of a moldable member of the face mask; placing the face mask against the face of the user; applying a force to the face mask in a direction towards the face of the user to conform the moldable member of the face mask to the face of the user; withdrawing the face mask from the face of the user; and cooling the face mask to decrease the malleability of the moldable member.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatus of the present specification. In the drawings:

FIG. 1 is a perspective view of a face mask, according to one embodiment;

FIG. 2 is an exploded view of the face mask of FIG. 1 showing a shell removed from a support and seal;

FIG. 3 is another exploded view of the face mask of FIG. 1 showing the shell, the support and the seal separated from each other;

FIG. 4 is a side view of the seal of FIG. 2;

FIG. 5 is a cross-sectional view of a shell and seal of a face mask, according to another embodiment;

FIG. 6 a perspective view of a face mask having a moldable member coupled to the face seal and configured to rest against edge of support when the face mask 10b is worn by a user, according to one embodiment;

FIG. 7 is a flow chart showing a method of conforming a face mask to a face of a user, according to one embodiment;

FIG. 8 is a pictorial representation of a first step of a method of conforming a face mask to a face of a user, according to one embodiment;

FIG. 9 is a pictorial representation of a first step of a method of conforming a face mask to a face of a user, according to another embodiment

FIG. 10 is a pictorial representation of a third step of a method of conforming a face mask to a face of a user, according to one embodiment; and

FIG. 11 is a pictorial representation of a fifth step of a method of conforming a face mask to a face of a user, according to one embodiment.

### DETAILED DESCRIPTION

Various apparatus or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, or “directly fastened” where the parts are connected in physical contact with each other. None of the terms “coupled”, “connected”, “attached”, and “fastened” distinguish the manner in which two or more parts are joined together.

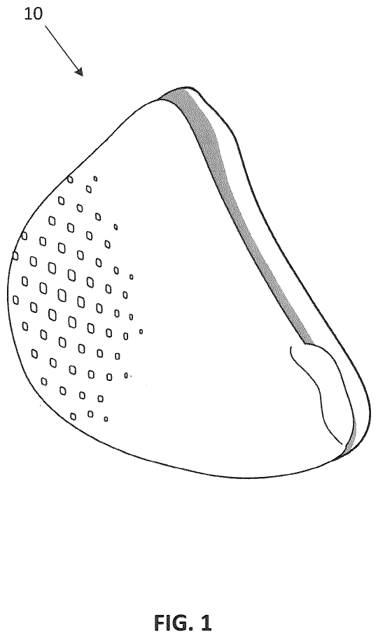

Referring to FIG. 1, illustrated therein is a face mask 10 for filtering air. More particularly, the face mask 10 is a respiratory mask for filtering pollutants and particulate based airborne contaminants from the air when positioned over the face of a user. Air is drawn in by the user's breath and pollutants are filtered out and prevented from entering the respiratory system of the user. As the user exhales, the face mask 10 expels the exhaled air. The face mask 10 includes components that may provide ease of manufacture and simple assembly and replacement of parts for the user. Pollutants and airborne contaminants filtered may include carbon monoxide, nitrogen oxides, ozone, sulphur, PM2.5, PM10, and pollen. Pollen from plants may be filtered by the face mask 10 to prevent allergies and reactions in humans.

In an embodiment, the face mask 10 may filter any one or more of combustive atmospheric pollutants, motor vehicle emissions, power plant emissions, wood burning emissions, forest fire emissions, and agricultural burning emissions. The face mask 10 may be more effective than comparative products against <0.5 m airborne bacteria. The face mask 10 may be more effective then comparative products against <2.5 m combustive pollutants.

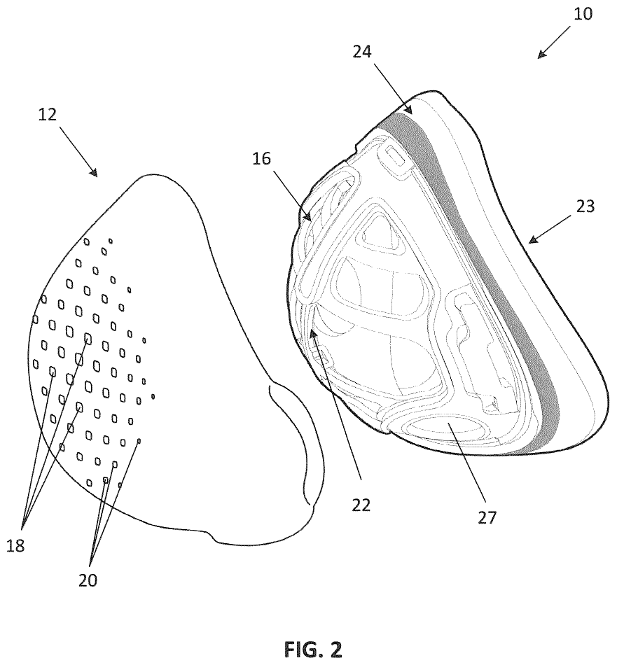

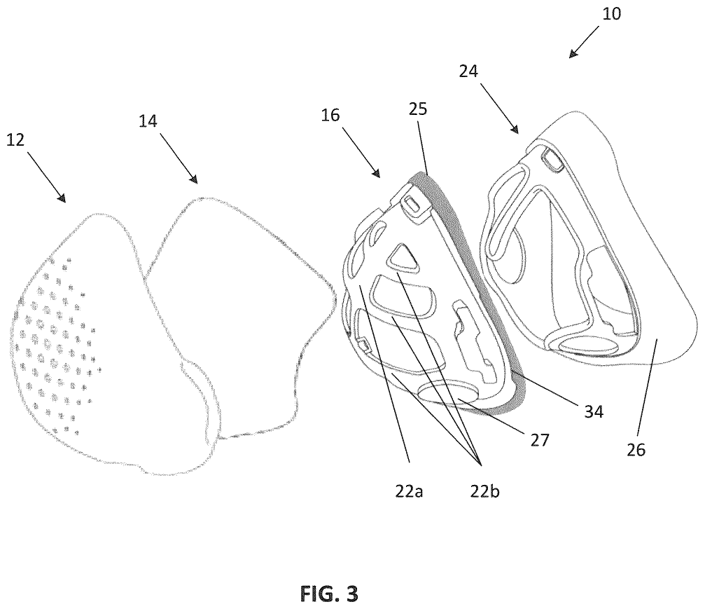

Referring now to FIG. 2, the face mask 10 includes a front shell 12 that acts as an outer layer of the face mask 10 and provides a protective outer surface. The front shell 12 attaches to a support 16 and the front shell 12 and the support 16 co-operate to support and hold a filter 14 (see FIG. 3) therebetween. The support 16 provides structure to and supports the filter 14 in the face mask 10 while the front shell 12 protects the filter 14 and inner components of the face mask 10. The face mask 10 may include a head strap (not shown) attached to one or more of the front shell 12 and the support 16 for holding the face mask 10 against a user's head.

The front shell 12 may be made of rigid, semi-rigid, or flexible material such as thermoplastic, carbon fiber, and plastic. The front shell 12 may also include an aesthetic layer made of materials such as gold, platinum, and flexible materials such as lace, leather, fabrics, and silk. In certain embodiments, the front shell 12 may be attached to various clothing-type garments, such as, scarfs, jackets, balaclavas, sweaters, and helmets. The front shell 12 may be attached to the clothing-type garments using, for example, magnets, buttons, and other fasteners.

The front shell 12 may be exchangeable such that, the front shell 12 can have various patterns, sizes, colors, shapes, animal faces, etc. The front shell 12 may accessorize the outside of the face mask 10. The face mask 10 may include a head strap 28 attached to the front shell 12 for holding the face mask 10 to a user's head.

The front shell 12 has inlet holes 18 for allowing incoming air to pass in to the face mask 10 and through to the filter 14, where the filter 14 filters particulate elements from the air. The filter 14 is secured between the front shell 12 and the support 16.

The front shell 12 also has exhale ports 20 separate from the inlet holes 18, which allow exhaled air to pass out of face mask 10. The exhale ports 20 allow exhaled air to outlet the face mask 10 so that the exhaled air does not have to pass back through the inlet holes 18 thereby degrading the filter 14 from the inside.

Turning now to FIG. 3, illustrated therein is a face mask 10 including the support 16 and the face seal 24.

The support 16 includes a framework 22 having longitudinal 22a and transverse frame members 22b to support the filter 14 and open area (e.g. cavity) 23 for allowing air to flow through. In an embodiment, the framework 22 includes a central longitudinal frame member 22a and at least two transverse frame members 22b. The filter 14 rests between the front shell 12 and the framework 22 and over the open area 23. The support 16 has exit valves 27 (e.g. one exit valve 27 on each side of the support 16) that lead to the exhale ports 20 on the front shell 12.

The face mask 10 also includes a face seal 24 attached to the support 16 for providing a flexible portion that rests against the user's face around the nose and mouth of the user and provides comfort to the user when wearing the face mask 10. As shown in the Figures, the face seal 24 may be attached to the periphery of the support 16 for providing a flexible seal around the nose and mouth of the user when wearing the face mask 10. The face seal 24 contacts (e.g. rests against) the user's face and is sized and shaped to surround the nose and the mouth of the user when the user wears the face mask 10. The face seal 24 provides a snug seal between the face mask 10 and the user's face when the face mask 10 is worn by the user to inhibit a passage of air around the face mask 10 and into the mouth and/or nose of the user. The face seal 24 may therefore direct a passage of air caused by inhalation and/or expiration of the user through the filter 14.

In the embodiments shown in the Figures, the face seal 24 is attached to the periphery of the support 16. The face seal 24 is coupled to the support 16 rearward of the support 16 and rearward of the front shell 12 to rest against the face of the user when the user wears the face mask 10.

In some embodiments, the face seal 24 is made of silicone. The face seal 24 may also include a phase change material such as a cooling gel to cool the user's face in warm environments or to warm the user's face in cool environments. In some cases, the face seal 24 is customized for a specific user, in other cases the face seal 24 can flexibly accommodate a variety of shapes and sizes of a user's face. The face seal 24 may also be flexible such that a user can move their mouth and face (for example, to talk) while continuing to maintain a snug seal with the user's face. In some cases the face seal 24 forms an air tight seal with the user's face when the face mask 10 is worn by the user. In other embodiments, the face seal 24 does not form an air tight seal, however, the more air that passes between the face of the user and the face seal 24, the more opportunity the face seal 24 will not filter pollutants in the air through the filter 14.

The face mask 10 also includes a moldable member 25 capable of conforming to the user's face upon the application of heat and force. For example, when the user activates moldable member 25 (e.g. by heating) to make the moldable member malleable and the presses the moldable member 25 to its face, moldable member 25 is capable of conforming to the shape of the user's face to provide comfort, support, protection and/or shock absorption when the user wears the face mask 10.

Moldable member 25 may be a single, continuous moldable member that extends from the edge 34 of support 16 and surrounds support 16. In another embodiment (not shown), moldable member 25 may comprise a plurality of moldable members separated from each other that each extend from the edge 34 of support 16 and that co-operate to substantially surround the support 16. For instance, in one specific embodiment, moldable member 25 may comprise four separate moldable members extending from the edge 34 of support 16, one moldable each positioned adjacent to one of the user's nose, cheek bones and chin when the face mask 10 is worn by the user.

Moldable member 25 can be made of any material that has a defined shape at approximately room temperature (i.e. ˜20° C.) and then becomes malleable (i.e. capable of changing shape upon the application of force without breaking) upon heating. In this manner, moldable member 25 is capable of conforming to the face of the user upon: i) being heated above a moldable point (i.e. a temperature at which the moldable member becomes malleable); ii) being applied to a face of a user (e.g. resting against the face of the user); and iii) receiving a force in a direction towards the face of the user.

In some embodiments, moldable member 25 is a polymeric composition comprising one or more of gelling agents, resiliency components and softening agents.

In these embodiments, moldable member 25 may be an acrylate-based polymer, a methacrylate-based polymer, a polyolefin elastomer, a ethylene-vinyl-based polymer or a combination thereof or any other appropriate thermoplastic polymerized composition as plasticizer. In some embodiments the composition may include a mixture of dibutyl phthalate and dioctyl phthalate. In some embodiments, ethylene glycol dimethacrylate may be used as a cross-linking agent.

In these embodiments, the gelling agents provide rigidity to the composition. Suitable gelling agents are thermoplastic polymers. Preferably, the thermoplastic polymer is environmentally safe and can be heated by microwave. Example gelling agents that may be used in the moldable member include but are not limited to:

In these embodiments, the resiliency compounds provide rigidity to the composition. Suitable gelling agents are thermoplastic polymers. Preferably, the thermoplastic polymer is environmentally safe and can be heated by microwave. Example gelling agents that may be used in the moldable member include but are not limited to:

In these embodiments, the softening agents should are non-toxic, have no smell and provide for a final product with little tack. In accordance with a preferred embodiment, the softening agent is mineral oil. Suitable softening agents may include, but are not limited to, dodecane, diamylphthalate, dibutylsebacate, diisodecylphthalate, dioctyladipate, dioctyl phthalate, dioctylsebacate, ethylbenzoate, tricresyl phosphate, turpentine, pine oil, propyl butyrate, Solvesso 150 and terpene. Example gelling agents that may be used in the moldable member include but are not limited to:

For example, in one embodiment, moldable member 25 may be firm and have a defined shape when at room temperature (i.e. ˜20° C.) and become malleable (e.g. become capable of changing shape and/or have a molding point) upon being heated to a temperature in a range of about 25° C. to about 100° C., or in a range of about 35° C. to about 75° C., or in a range of about 45° C. to about 65° C., or to a temperature of about 60° C.

In some embodiments, depending upon the relative proportions of ingredients used to form moldable member 25, moldable member 25 can be a soft gel-like material or a firm rubber-like material that retains its shape through the full range of temperatures below its molding point. As moldable member 25 is heated and approaches its molding point, moldable member 25 begins to become malleable and may be conformed to virtually any shape desired. As moldable member 25 cools from its molding point, it loses its malleability and retain its consistency as well as the shape it was given in the molding process.

In some embodiments, moldable member 25 is remoldable and reusable (e.g. can be remolded and reused repeatedly).

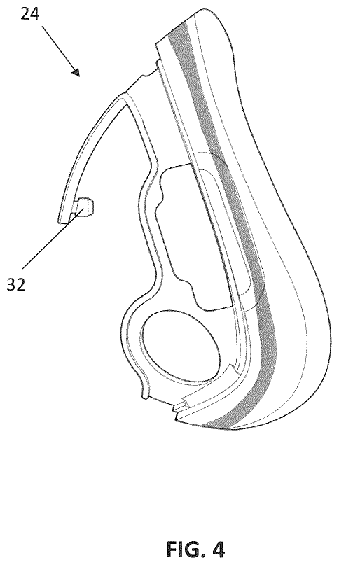

In the embodiment shown in FIGS. 3 and 4, moldable member 25 is coupled to and extends from the periphery of support 16. In this embodiment, moldable member 25 is continuous and surrounds a peripheral edge (e.g. rear edge 34) of support 16 to rest against a user's face (e.g. between the user's face and support 16) when the mask 10 is worn by the user.

In some embodiments, moldable member 25 may be directly attached to and extend outwardly from a peripheral edge (e.g. rear edge 34) of the periphery of support 16. In this embodiment, face seal 24 is also directly attached to the support 16, such as but not limited to via anchor points such as but not limited to anchor point 32, and can be configured to cover the moldable member 25 when the face mask 10 is worn by the user. For instance, when the mask 10 shown in FIGS. 3 and 4 is worn by a user, an extending portion 26 of the face seal 24 presses directly against the face of the user and the moldable member 25 lies between the face seal 24 and the support 16. In this embodiment, extending portion 26 of the face seal 24 can act as a buffer between the user's face and the moldable member 25 to inhibit passage of air between the open area 23 of support 16 and the environment that does not pass through the filter 14. Extending portion 26 is configured to extend outwardly from the periphery of support 16 to substantially cover and wrap around moldable member 25, which substantially covers and surrounds rear edge 34 of the periphery of support 16. Extending portion 26 can house moldable member 25 in a pocket (not shown) defined by extending potion 26. Extending portion 26 can also have a free end (not shown) that extends inwardly towards the open area 23 of support 16 to define the pocket (not shown).

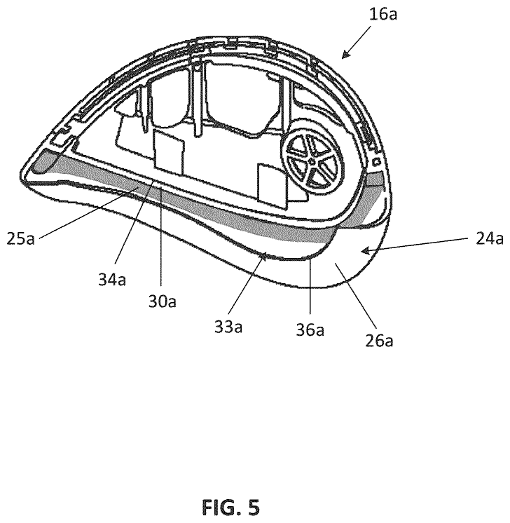

Referring now to FIG. 5, in another embodiment of a face mask 10a, rear edge 34a of the periphery of support 16a can be covered by a lip 30a of seal 24a and moldable member 25a can be coupled to and extend outwardly from the lip 30a of seal 24a. Similar to the embodiment shown in FIGS. 3 and 4, in this embodiment, face seal 24a is directly attached to support 16a (such as but not limited to via anchor points such as but not limited to anchor 32) and extends outwardly from the periphery of support 16. Lip 30a of face seal 24a can cover rear edge 34a of support 16a and can be configured to provide a smooth, continuous surface that faces the face of the user (e.g. when the face mask 10 is worn by the user) for moldable member 25a to rest against and couple thereto.

In this embodiment, extending portion 26a of face seal 24a is configured to extend outwardly from the periphery (e.g. rear edge 34a) of support 16a adjacent to rear edge 34a of support 16a and lip 30a of seal 24a and to substantially cover and wrap around moldable member 25 that is coupled to lip 30a of seal 24a. Extending portion 26a can house moldable member 25a in a pocket 33a defined by extending potion 26a. As shown in FIG. 5, extending portion 26a can have a free end 36a that extends inwardly towards the open area 23a of support 16a to define pocket 34a. In other embodiments, extending portion 26a may not have a free end 36a as shown, but may rather form an enclosure around any one or all of lip 30a, rear edge 34a and moldable member 25a.

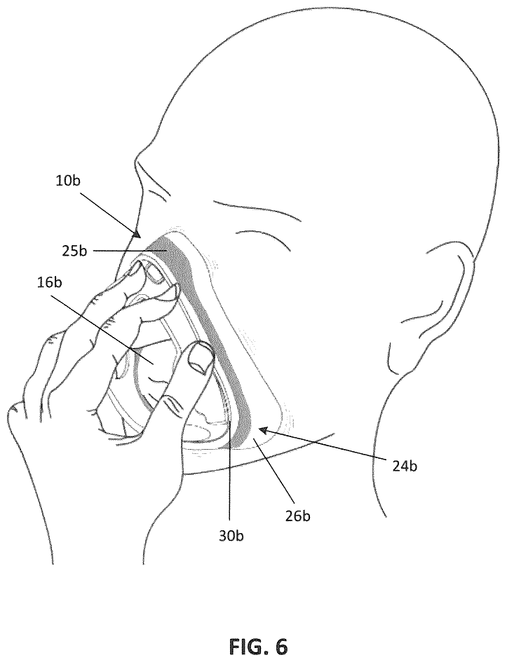

In another embodiment (not shown), moldable member 25b may be coupled to the face seal 24b and configured to rest against edge 30b of support 16b when the face mask 10b is worn by a user. In this embodiment, moldable member 25b may be coupled to an inner surface of an extending portion 26b of face seal 24b. Extending portion 26b may have a free end (not shown) that extends towards an open area (not shown) of the support 16b to define a pocket of the extending portion 26b (see FIG. 5 for example). Alternatively, extending portion 26b may form an enclosure around any one or all of lip 30b, rear edge 34b and moldable member 25b. FIG. 6 shows an example of a mask 10b having a moldable member 25b coupled to the face seal 24b and configured to rest against edge 30b of support 16b when the face mask 10b is worn by a user.

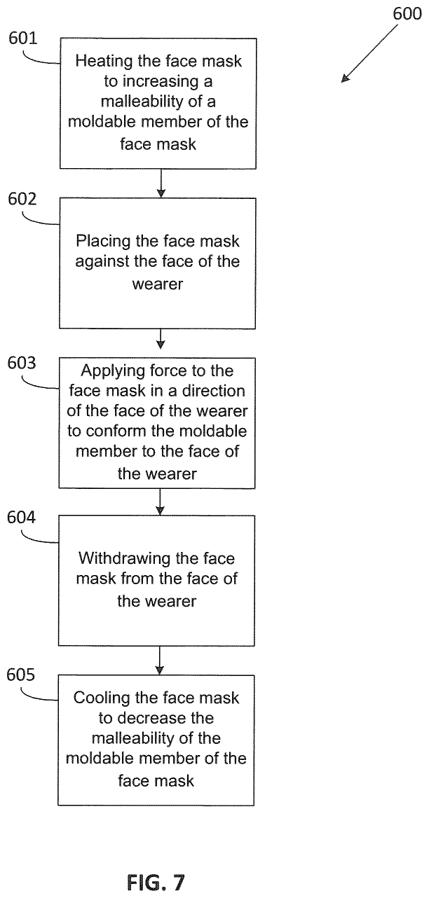

Referring now to FIGS. 7-11, illustrated therein are steps to a method of confirming a face mask to a user's face.

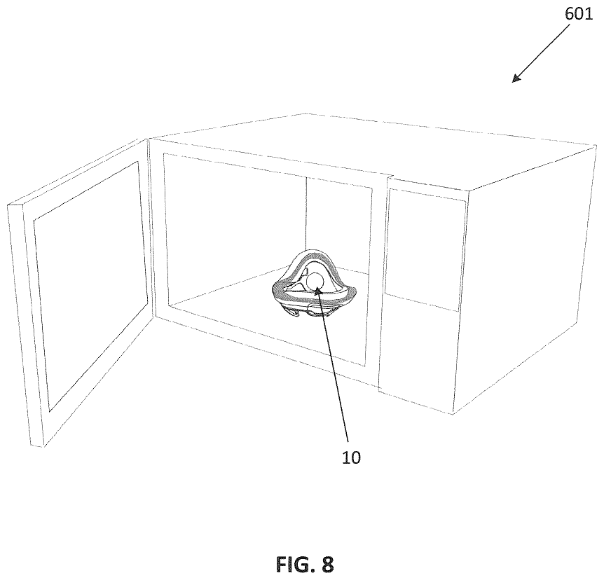

FIG. 7 is a schematic illustration of a method 600 of confirming a face mask to a user's face. At first step 601, a face mask 10 is heated to change the malleability of a moldable member 25 of the face mask 10. Generally, a room temperature, moldable member 25 is not malleable and is a rigid, polymeric material. Upon heating moldable member 25 (as described above), its malleability increases and the moldable member 25 can change shape upon the application of force. A person skilled in the art would understand that various mechanisms for transferring heat to the moldable member 25 of mask 10 to change the malleability of the moldable member 25. In the embodiment shown in FIG. 8, the face mask 10 is shown as being heated in a microwave for a period of time (see FIG. 8). It should be noted that in the embodiment shown in FIG. 8, the face mask 10 is shown as being heated in a microwave with the front shell 12 and the filter 14 having been removed. Removal of front shell 12 and filter 14 inhibit exposure of the filter 14 to potentially harmful means during the heating process. Further, the face mask 10 may be positioned such that the moldable member 25 is facing upwards within the microwave. This may improve the exposure of the moldable member 25 when heating.

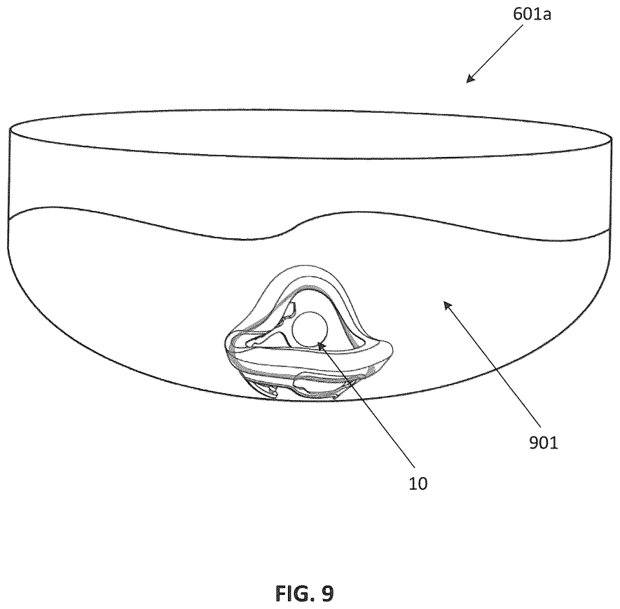

In another embodiment shown in FIG. 9, first step 601a may include heating a face mask 10 by inserting (e.g. immersing) the face mask 10 into a hot liquid (e.g. water) 901 for a period of time. Again, it should be noted that the filter 14 should be removed from the face mask 10 prior to immersing the face mask 10 in the hot liquid. The skilled person will understand that there may be methods of heating face mask 10 that do not require the removal of front shell 12 and/or filter 14.

The period of time to heat the moldable member 25 of the face mask 10 will depend on many factors including but not limited to the power of the microwave, the temperature of the water, the size of the mask, the thickness of the moldable member 25, etc. The period of time to heat the moldable member 25 will end when the temperature of the moldable member 25 exceeds its molding point (i.e. a temperature at which the moldable member 25 becomes malleable).

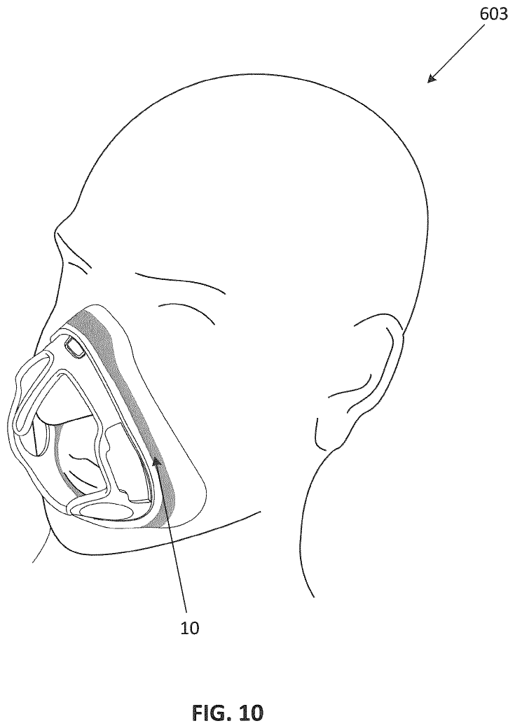

At step 602, shown in FIG. 10, face mask 10 is applied to the face of the user 11. Face mask 10 substantially surrounds the nose and mouth of the user when the face mask 10 is applied to the user's face. Generally, when the nose and the mouth of the user 11 are surrounded by the face mask 10 and a seal is formed between the user's face and the face mask 10, face mask 10 is positioned to mimic a position of how the user 11 would wear the face mask 10 and the user 11 may proceed to the third step.

At step 603 a force is applied to the face mask 10 in a direction towards the face of the user 11 to conform the moldable member 25 to the shape of the underlying face to the user 11. Upon application of the force towards the face of the user 11, the lip 30 of support 16 moves in a direction towards the face of the user 11 and presses against the face of the user 11. In the embodiments described herein, the moldable member 25 is positioned between the lip 30 of the support 16 and the face of the user 11, so the moldable member 25 receives a force from the lip 30 and conforms to the face of the user 11 resting against the moldable member 25 (either directly or via the extending portion 26). Moldable member 25 therefore, when heated, conforms to the shape of the face of the user 11. The user should gently but firmly press the mask against their face until they can feel heat around the entire silicon seal and hold for a period of time ranging from approximately 45 seconds to one minute. The user should then remove the mask and place it in cold water for a period of time ranging from one to five minutes, or for a period of time ranging from two to three minutes. The mask should then fully seal around the nose, chin and cheeks. If a gap is noticed, repeat the process.

At step 604, the face mask 10 is withdrawn from the face of the user 11.

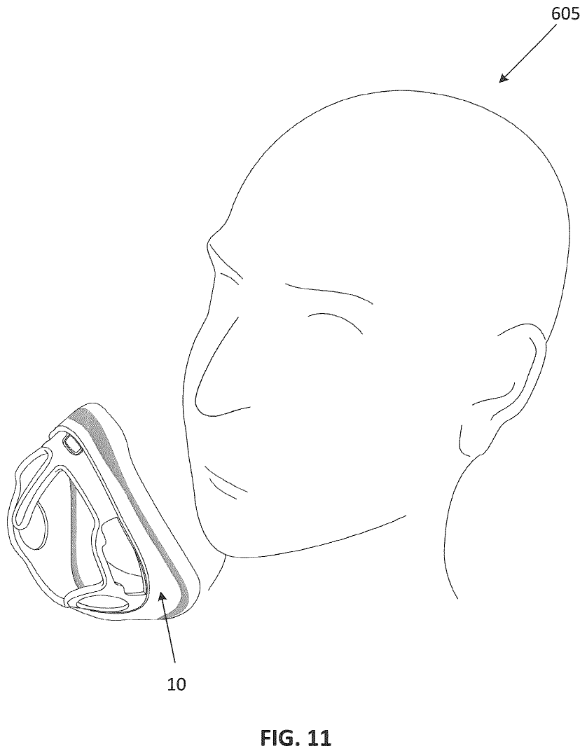

At step 605, shown in FIG. 11, the face mask 10 is allowed to cool. Cooling the moldable member 25 provides for the moldable member 25 to lose its malleability and retain the shape that was formed during step 603. For instance, upon reaching about room temperature, moldable member 25 will generally lose its malleability and become a rigid polymeric material that conforms to the face of the user 11.

While the above description provides examples of one or more apparatus, methods, or systems, it will be appreciated that other apparatus, methods, or systems may be within the scope of the claims as interpreted by one of skill in the art.

1. A face mask for filtering air, the face mask comprising:
a support defining an open area that provides for passage of air between the mouth and environment;
a seal coupled to the support and extending rearwardly from the support, the seal sized and shaped to surround a nose and a mouth of a user and support the face mask on the user's face when the face mask is worn by the user;
a moldable member extending rearwardly from a rear edge of the support, the moldable member increasing in malleability upon the application of heat and decreasing in malleability upon cooling;
a front shell for removably attaching to the support, the front shell having inlet holes for facilitating passage of incoming air through the open area of the support; and
a filter for filtering particulate elements from air, the filter configured to be housed between the front shell and the support.

2. The face mask of claim 1, wherein the seal includes an extending portion adjacent to the rear edge of the support and the moldable member is housed within the extending portion.

3. The face mask of claim 1, wherein the moldable member is coupled to the support.

4. The face mask of claim 3, wherein the moldable member is coupled to the rear edge of the support.

5. The face mask of claim 1, wherein the seal includes a lip and the lip is positioned to cover the rear edge of the support.

6. The face mask of claim 5, wherein the moldable member is coupled to the lip of the support.

7. The face mask of claim 1, wherein the moldable member is coupled to the seal and rests against the support.

8. The face mask of claim 7, wherein the moldable member is coupled to an inner surface of the seal.

9. The face mask of claim 2, wherein the extending portion includes a free end that extends inwardly towards the open area of the support to house the moldable member.

10. A method of conforming a face mask to a face of a user, the method comprising:
heating the face mask to increase a malleability of a moldable member of the face mask;
placing the face mask against the face of the user;
applying a force to the face mask in a direction towards the face of the user to conform the moldable member of the face mask to the face of the user;
withdrawing the face mask from the face of the user; and
cooling the face mask to decrease the malleability of the moldable member.

11. The method of claim 10, wherein the heating comprises heating the face mask until the moldable member exceeds its molding point.

12. The method of claim 11, wherein the molding point is in a range from about 25° C. to about 100° C.

13. The method of claim 11, wherein the molding point is in a range from about 35° C. to about 75° C.

14. The method of claim 11, wherein the molding point is in a range from about 45° C. to about 65° C.

15. The method of claim 11, wherein the molding point is about 60° C.

16. The method of claim 10, wherein the applying a force is for a period of time in a range from about 45 seconds to one minute.

17. The method of claim 10, wherein the cooling comprises cooling the face mask until the moldable member reaches a temperature of about room temperature.

18. (canceled)

19. The face mask of claim 1, wherein the seal is coupled to the support at an anchor point.

20. The face mask of claim 2, wherein the extending portion extends outwardly from the support to cover the moldable member.

21. The face mask of claim 2, wherein the extending portion is configured to inhibit the passage of air between the open area of the support and the environment that does not pass through the filter.
